(19) United States
(12) Patent Application Publication
(10) Pub. No.: US 2004/0032138 A1
(43) Pub. Date: Feb. 19, 2004

(54) Form lift apparatus

(76) Inventor: Daniel E. Bancroft, New Smyrna Beach, FL (US)

Correspondence Address: S. Michael Bender, P.O. Box 530399, St. Petersburg, FL, 33747, US

(21) Appl. No.: 10/223,120

(22) Filed: Aug. 17, 2002

(51) Int. Cl. B66C 1/34

(52) U.S. Cl. 294/67.22; 294/82.23

(57) ABSTRACT

A form lift apparatus includes a first support portion which includes a hanger-reception channel and lateral-support-member reception slots. A second support portion is connected to the first support portion at a substantially right angle and includes a lateral support member. The lateral support member has a top lateral support portion and a front lateral support portion connected to the top lateral support portion. The top lateral support portion includes a front transverse portion, slot-received portions connected to the front transverse portion, and a rear transverse portion connected to the slot-received portions. The second support portion includes a form-member-reception cut out portion. The form-member-reception cut out is located medially between ends of the second support portion. The first support portion is oriented substantially vertically, and the second support portion is oriented substantially horizontally.

### BACKGROUND OF THE INVENTION

1. Field of the Invention

The present invention relates generally to devices for lifting objects and, more particularly, to a device especially adapted for holding a construction form that is to be lifted.

2. Description of the Prior Art

Devices for lifting objects are well known in the art. In a number of environments, especially at construction sites, objects are often lifted by an overhead lifting device, such as a crane, which has a descending cable or chain and which also has an object-attaching device at the end of the cable or chain. In this respect, throughout the years, a number of innovations have been developed, and the following U.S. patents are representative of some of those innovations: U.S. Pat. Nos. 2,399,433, 2,526,085, 2,620,219, and 3,089,726. The devices disclosed in each of U.S. Pat. Nos. 2,399,433, 2,526,085, 2,620,219, and 3,089,726 share a number of common characteristics. Each device has a pair of jaws, and each jaw exerts a gripping action on an object to be lifted. In addition, each of the jaws is supported by a hinged element that is connected to the overhead cable or chain. Because both jaws are independently hinged, either of the jaws, or both of the jaws, have a potential for moving around its respective hinge and losing its grip on the object to be lifted, whereby the object to be lifted would fall, creating significant hazards. In this respect, to avoid such a danger, it would be desirable if an object lifting device were provided that does not employ two jaws, which are both supported by a hinged element that is connected to an object to be lifted.

Furthermore, each of U.S. Pat. Nos. 2,399,433, 2,526,085, and 2,620,219 discloses an object gripping device that provides no support directly under the location where the overhead cable or chain is connected to the object gripping device. With these devices, the lifting forces are provided by gripping the sides of the object to be lifted. If the side portions of the object to be lifted slip or are sheared, the object to be lifted can slip out from under the gripping device. To avoid this danger, it would be desirable if an object lifting device were provided that includes a portion that is located directly under the location where the overhead cable or chain is connected to the object gripping device.

Above mentioned U.S. Pat. No. 3,089,726 discloses a grapple which has two hinged jaws which can interleave when lifting an object. As a result, portions of the interleaved jaws are located along a plumb line under the location where the overhead cable or chain is connected to the object gripping device. However, as stated above, both jaws are hinged. Consequently, either or both jaws can swing out from under the object to be lifted. Moreover, when the two jaws are interleaved, there is no object-supporting-surface in either jaw that is oriented horizontally. Each jaw has an inside curved surface, and neither curved surface has a horizontal tangent. The only portions of the interleaved jaws that are located along a plumb line under the location where the overhead cable or chain is connected to the object gripping device are the portions of the interleaved curved jaws that overlap. With such jaws, an overly rapid lifting operation for a heavy object could cause the object to be lifted to slip out from between the interleaved jaws. To overcome this danger, it would be desirable if an object lifting device were provided that includes a substantially horizontally oriented surface that is located along a plumb line under the location where the overhead cable or chain is connected to the object gripping device.

As a matter of interest, U.S. Pat. No. 5,013,326 discloses an artificial hand, which is a prosthetic device attached directly to a person. Both a thumb portion and a set of fingers portion are independently hinged.

Still other features would be desirable in a form lift apparatus. Construction forms of particle interest are forms which include a horizontally oriented portion and a vertically oriented portion that intersect in a T-shaped fashion. In this respect, it would be desirable if a construction form lifting device were provided that engages both horizontally oriented and vertically oriented construction form portions simultaneously during a lifting operation.

When a lifted object is moved horizontally, there may be a tendency for the lifted object to slip off a substantially horizontally oriented support member. To prevent such a slip off, it would be desirable if a construction form lifting device were provided that includes a portion that prevents the form from slipping off the device horizontally.

Thus, while the foregoing body of prior art indicates it to be well known to use devices for gripping objects from an overhead cable or chain, the prior art described above does not teach or suggest a form lift apparatus which has the following combination of desirable features: (1) does not employ two jaws, which are both supported by a hinged element that is connected to an object to be lifted; (2) includes a portion that is located along a plumb line under the location where the overhead cable or chain is connected to the object gripping device; (3) includes a substantially horizontally oriented surface that is located along a plumb line under the location where the overhead cable or chain is connected to the object gripping device; (4) provides a construction form lifting device that engages both horizontally oriented and vertically oriented construction form portions simultaneously during a lifting operation; and (5) includes a portion that prevents the form from slipping off the device horizontally. The foregoing desired characteristics are provided by the unique form lift apparatus of the present invention as will be made apparent from the following description thereof. Other advantages of the present invention over the prior art also will be rendered evident.

### SUMMARY OF THE INVENTION

To achieve the foregoing and other advantages, the present invention, briefly described, provides a form lift apparatus which includes a first support portion which includes a hanger-reception channel and lateral-support-member reception slots. A second support portion is connected to the first support portion at a substantially right angle and includes a lateral support member. The lateral support member has a top lateral support portion and a front lateral support portion connected to the top lateral support portion. The top lateral support portion includes a front transverse portion, slot-received portions connected to the front transverse portion, and a rear transverse portion connected to the slot-received portions.

The lateral-support-member reception slots have a slot length. The front lateral support portion has a front portion length which is sufficiently long to reach the second support portion when the slot-received portions are located at top portions of the lateral-support-member reception slots.

The front lateral support portion is connected to the top lateral support portion at a front end of the top lateral support portion. The front lateral support portion is oriented with respect to the top lateral support portion substantially at a right angle. Preferably, the front transverse portion, the slot-received portions, and the rear transverse portion are located in a common plane.

Preferably, the second support portion includes a form-member-reception cut out portion. The form-member-reception cut out is located medially between ends of the second support portion. The first support portion is oriented substantially vertically, and the second support portion is oriented substantially horizontally.

The above brief description sets forth rather broadly the more important features of the present invention in order that the detailed description thereof that follows may be better understood, and in order that the present contributions to the art may be better appreciated. There are, of course, additional features of the invention that will be described hereinafter and which will be for the subject matter of the claims appended hereto.

In this respect, before explaining a preferred embodiment of the invention in detail, it is understood that the invention is not limited in its application to the details of the construction and to the arrangements of the components set forth in the following description or illustrated in the drawings. The invention is capable of other embodiments and of being practiced and carried out in various ways. Also, it is to be understood, that the phraseology and terminology employed herein are for the purpose of description and should not be regarded as limiting.

As such, those skilled in the art will appreciate that the conception, upon which disclosure is based, may readily be utilized as a basis for designing other structures, methods, and systems for carrying out the several purposes of the present invention. It is important, therefore, that the claims be regarded as including such equivalent constructions insofar as they do not depart from the spirit and scope of the present invention.

It is therefore an object of the present invention to provide a new and improved form lift apparatus which has all of the advantages of the prior art and none of the disadvantages.

It is another object of the present invention to provide a new and improved form lift apparatus which may be easily and efficiently manufactured and marketed.

It is a further object of the present invention to provide a new and improved form lift apparatus which is of durable and reliable construction.

An even further object of the present invention is to provide a new and improved form lift apparatus which is susceptible of a low cost of manufacture with regard to both materials and labor, and which accordingly is then susceptible of low prices of sale to the consuming public, thereby making such form lift apparatus available to the buying public.

Still yet a further object of the present invention is to provide a new and improved form lift apparatus which does not employ two jaws, which are both supported by a hinged element that is connected to an object to be lifted.

Still another object of the present invention is to provide a new and improved form lift apparatus that includes a portion that is located along a plumb line under the location where the overhead cable or chain is connected to the object gripping device.

Yet another object of the present invention is to provide a new and improved form lift apparatus which includes a substantially horizontally oriented surface that is located along a plumb line under the location where the overhead cable or chain is connected to the object gripping device.

Even another object of the present invention is to provide a new and improved form lift apparatus that provides a construction form lifting device that engages both horizontally oriented and vertically oriented construction form portions simultaneously during a lifting operation.

Still a further object of the present invention is to provide a new and improved form lift apparatus which includes a portion that prevents the form from slipping off the device horizontally.

These together with still other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawing wherein:

FIG. 1 is a bottom perspective view showing a preferred embodiment of the form lift apparatus of the invention in use lifting a construction form.

FIG. 2 is an enlarged side view of the embodiment of the form lift apparatus shown in FIG. 1 taken along line 2-2 of FIG. 1 and removed from the construction form.

FIG. 3 is a rear view of the embodiment of the form lift apparatus of FIG. 2 taken along line 3-3 thereof.

FIG. 4 is a top view of the embodiment of the invention shown in FIG. 3 taken along line 4-4 thereof.

FIG. 5 is a partial cross-sectional view of the embodiment of the invention shown in FIG. 3 taken along line 5-5 thereof.

FIG. 6 is a front top perspective view of the embodiment of the invention shown in FIGS. 1-5.

### DESCRIPTION OF THE PREFERRED EMBODIMENT

With reference to the drawings, a new and improved form lift apparatus embodying the principles and concepts of the present invention will be described.

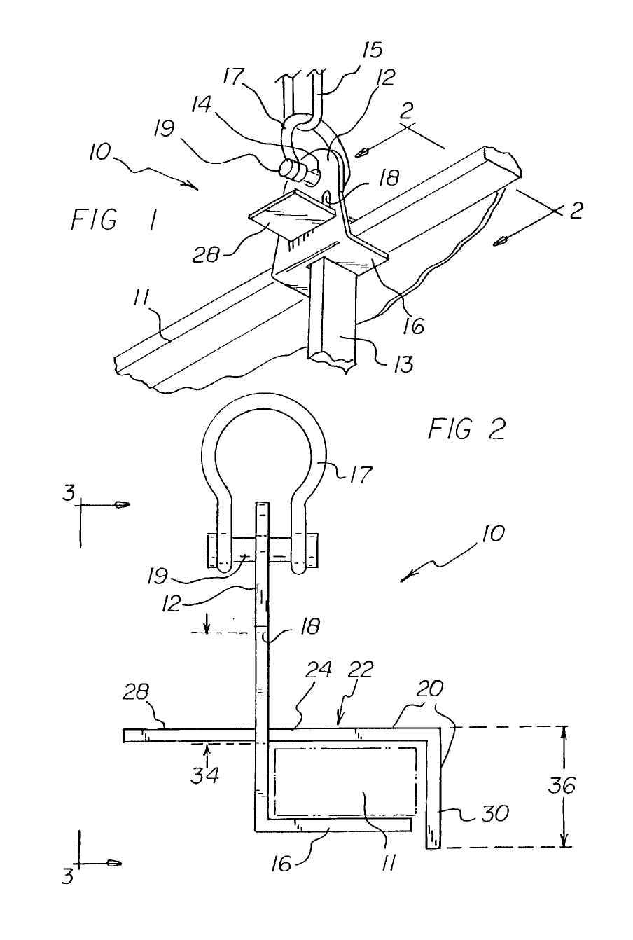

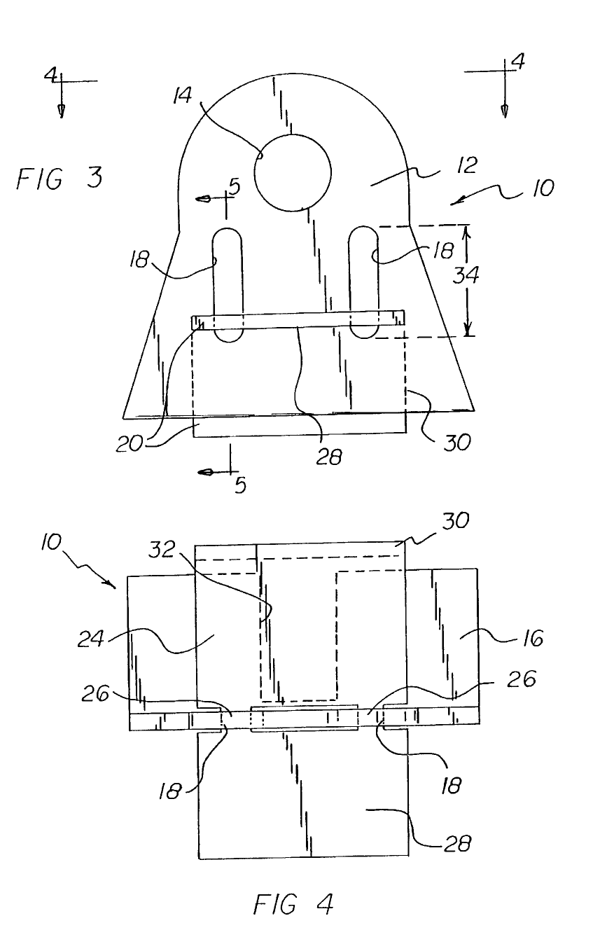

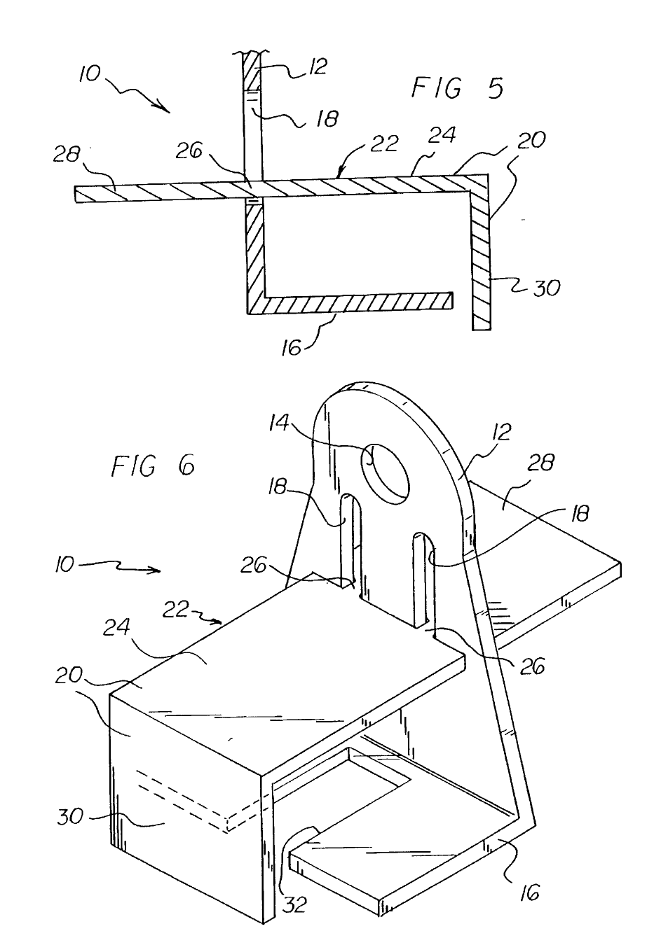

Turning to FIGS. 1-6, there is shown an exemplary embodiment of the form lift apparatus of the invention generally designated by reference numeral 10. In its preferred form, form lift apparatus 10 includes a first support portion 12 which includes a hanger-reception channel 14 and lateral-support-member reception slots 18. A second support portion 16 is connected to the first support portion 12 at a substantially right angle and includes a lateral support member 20. The lateral support member 20 has a top lateral support portion 22 and a front lateral support portion 30 connected to the top lateral support portion 22. The top lateral support portion 22 includes a front transverse portion 24, slot-received portions 26 connected to the front transverse portion 24, and a rear transverse portion 28 connected to the slot-received portions 26.

The lateral-support-member reception slots 18 have a slot length 34. The front lateral support portion 30 has a front portion length 36 which is sufficiently long to reach the second support portion 16 when the slot-received portions 26 are located at top portions of the lateral-support-member reception slots 18. When the top lateral support portion 22 is moved up and down with respect to the second support portion 16, the slot-received portions 26 ride up and down in the lateral support-member reception slots 18.

The front lateral support portion 30 is connected to the top lateral support portion 22 at a front end of the top lateral support portion 22. The front lateral support portion 30 is oriented with respect to the top lateral support portion 22 substantially at a right angle. Preferably, the front transverse portion 24, the slot-received portions 26, and the rear transverse portion 28 are located in a common plane.

Preferably, the second support portion 16 includes a form-member-reception cut out portion 32. The form-member-reception cut out 32 is located medially between ends of the second support portion 16. The first support portion 12 is oriented substantially vertically, and the second support portion 16 is oriented substantially horizontally.

To use the embodiment of the invention shown in FIGS. 1-6, on the construction form shown in FIG. 1, the form lift apparatus 10 is attached to an overhead cable or chain, as shown in FIG. 1. A lifting chain 15 has a ring 17 connected thereto. A clevis pin 19 is detached from a portion of the ring 17, and the clevis pin 19 is threaded through the hanger-reception channel 14. Then, the clevis pin 19 is reattached to the ring 17. In this way, the form lift apparatus 10 is connected to the overhead cable or chain.

Then, to affix the form lift apparatus 10 onto the construction form, the top lateral support portion 22 of the form lift apparatus 10 is lifted up so that the front lateral support portion 30 clears the horizontally oriented form portion 11. The first support portion 12 is moved towards the horizontally oriented form portion 11, and the form-member-reception cut out portion 32 is placed in registration with the vertically oriented form portion 13. Then, the vertically oriented form portion 13 is received in the form-member-reception cut out portion 32. The top lateral support portion 22 is lowered so that the front lateral support portion 30 extends beyond the horizontally oriented form portion 11 of the construction form. As a result, the construction form is securely retained or trapped in the form lift apparatus 10 of the invention.

The second support portion 16 is oriented horizontally and is located substantially along a plumb line (not shown) that extends downward from the overhead cable or chain. The second support portion 16 is oriented horizontally and prevents the construction form from falling downward from the form lift apparatus 10.

The front lateral support portion 30 and the front surfaces of the rear transverse portion 28 that are up against the first support portion 12 prevent the construction form from slipping forward off of the form lift apparatus 10. The inside walls of the form-member-reception cut out portion 32 that are up against the vertically oriented form portion 13 prevent the construction form from shifting sideways with respect to the construction form.

The lateral-support-member reception slots 18 have a slot length 34. The slot length 34 permits the form lift apparatus 10 of the invention to be used with horizontally oriented form portions 11 that have a wide variety of thicknesses, up to the slot length 34.

When the construction form is to be removed from the form lift apparatus 10, the front lateral support portion 30 is lifted up to clear the horizontally oriented form portion 11, and the construction form is slipped off of the second support portion 16.

With another embodiment of the invention, not shown in the drawings, the second support portion 16 can be full-bodied, without having a form-member-reception cut out portion 32 therein.

The components of the form lift apparatus of the invention can be made from inexpensive and durable metal and plastic materials.

As to the manner of usage and operation of the instant invention, the same is apparent from the above disclosure, and accordingly, no further discussion relative to the manner of usage and operation need be provided.

It is apparent from the above that the present invention accomplishes all of the objects set forth by providing a new and improved form lift apparatus that is low in cost, relatively simple in design and operation, and which may advantageously be used without employing two jaws, which are both supported by a hinged element that is connected to an object to be lifted. With the invention, a form lift apparatus is provided which includes a portion that is located along a plumb line under the location where the overhead cable or chain is connected to the object gripping device. With the invention, a form lift apparatus is provided which includes a substantially horizontally oriented surface that is located along a plumb line under the location where the overhead cable or chain is connected to the object gripping device. With the invention, a form lift apparatus provides a construction form lifting device that engages both horizontally oriented and vertically oriented construction form portions simultaneously during a lifting operation. With the invention, a form lift apparatus is provided which includes a portion that prevents the form from slipping off the device horizontally.

Thus, while the present invention has been shown in the drawings and fully described above with particularity and detail in connection with what is presently deemed to be the most practical and preferred embodiment(s) of the invention, it will be apparent to those of ordinary skill in the art that many modifications thereof may be made without departing from the principles and concepts set forth herein, including, but not limited to, variations in size, materials, shape, form, function and manner of operation, assembly and use.

Hence, the proper scope of the present invention should be determined only by the broadest interpretation of the appended claims so as to encompass all such modifications as well as all relationships equivalent to those illustrated in the drawings and described in the specification.

Finally, it will be appreciated that the purpose of the annexed Abstract is to enable the U. S. Patent and Trademark Office and the public generally, and especially the scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

What is claimed as being new and desired to be protected by LETTERS PATENT of the United States is as follows:

1. A form lift apparatus, comprising:
a first support portion which includes a hanger-reception channel and lateral-support-member reception slots,
a second support portion connected to said first support portion at a substantially right angle, and
a lateral support member which includes a top lateral support portion and a front lateral support portion connected to said top lateral support portion, wherein said top lateral support portion includes a front transverse portion, a slot-received portions connected to said front transverse portion, and a rear transverse portion connected to said slot-received portions.

2. The apparatus of claim 1 wherein said lateral-support-member reception slots have a slot length.

3. The apparatus of claim 2 wherein said front lateral support portion has a front portion length.

4. The apparatus of claim 3 wherein said front lateral support portion has a front portion length which is sufficiently long to reach said second support portion when said slot-received portions are located at top portions of said lateral-support-member reception slots.

5. The apparatus of claim 1 wherein said front lateral support portion is connected to said top lateral support portion at a front end of said top lateral support portion.

6. The apparatus of claim 1 wherein said front lateral support portion is oriented with respect to said top lateral support portion substantially at a right angle.

7. The apparatus of claim 1 wherein said front transverse portion, said slot-received portions, and said rear transverse portion are located in a common plane.

8. The apparatus of claim 1 wherein said second support portion includes a form-member-reception cut out portion.

9. The apparatus of claim 8 wherein said form-member-reception cut out is located medially between ends of said second support portion.

10. The apparatus of claim 1 wherein:
said first support portion is oriented substantially vertically, and
said second support portion is oriented substantially horizontally.
